(19) United States
(12) Patent Application Publication
(10) Pub. No.: US 2007/0292756 A1
(43) Pub. Date: Dec. 20, 2007

(54) NON-AQUEOUS ELECTROLYTE SECONDARY BATTERY

(75) Inventor: Kenji Tsuchiya, Fukushima (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/763,255

(22) Filed: Jun. 14, 2007

(30) Foreign Application Priority Data
Jun. 16, 2006 (JP) P2006-167907

(51) Int. Cl. H01M 4/02; H01M 10/40

(52) U.S. Cl. 429/209; 429/303

(57) ABSTRACT

A non-aqueous electrolyte secondary battery is provided. The battery includes a cathode containing at least a cathode active material, an anode containing at least an anode active material, and a non-aqueous electrolyte. A specific surface area of the cathode active material ranges from 0.1 m²/g or more to 0.8 m²/g or less, and a specific surface area of the anode active material ranges from 0.2 m²/g or more to 5.0 m²/g or less.

### CROSS REFERENCES TO RELATED APPLICATIONS

The present application claims priority to Japanese Patent Application JP 2006-167907 filed in the Japanese Patent Office on Jun. 16, 2006, the entire contents of which being incorporated herein by reference.

### BACKGROUND

The present disclosure relates to a non-aqueous electrolyte secondary battery and, more particularly, to a lithium ion secondary battery having excellent cycle characteristics.

Owing to the remarkable development of recent portable electronic technique, electronic apparatuses such as cellular phone, laptop computer, and the like have been recognized as fundamental techniques which support an advanced information society. Further, research and development regarding a technique for realizing advanced functions of those apparatuses have been performed. In proportion to the electronic apparatus, electric power consumption is also increasing more and more. On the contrary, it is requested that those electronic apparatuses can be driven for a long time and the realization of a high energy density of a secondary battery as a driving power source is inevitably requested.

It is preferable that the energy density of the battery is as high as possible from a viewpoint of an occupation volume, a weight, and the like of the battery which is built in the electronic apparatus. At present, to satisfy such a request, a non-aqueous electrolyte battery, particularly, the lithium ion secondary battery using doping and dedoping lithium ions is built in most of the electronic apparatuses since it has an excellent energy density.

Ordinarily, in the lithium ion secondary battery, a cathode and an anode are used. The cathode is constructed by forming a cathode active material layer using a lithium composite oxide such as lithium cobalt acid or the like onto a cathode collector. The anode is constructed by forming an anode active material layer using, for example, a carbon material onto an anode collector. An operating voltage is set to a value within a range from 2.5 to 4.2 V. In a cell, a terminal voltage can be raised to 4.2V mainly owing to an excellent electrochemical stability of a non-aqueous electrolyte material, a separator, or the like.

According to the lithium ion secondary battery having such a construction, although a high voltage in which a charge/discharge electric potential exceeds 4V is obtained, there occurs such a problem that, particularly, an oxidation atmosphere is enhanced near the cathode surface, so that the non-aqueous electrolyte which is physically come into contact with the cathode is easily oxidation-decomposed. Thus, the non-aqueous electrolyte deteriorates, a reaction between the cathode active material and the non-aqueous electrolyte decreases, and a battery capacitance decreases gradually in association with the progress of a charge/discharge cycle. It is, therefore, requested to further improve cycle characteristics in the lithium ion secondary battery.

For this purpose, there is examined a method whereby by setting a specific surface area of the cathode active material of the lithium ion secondary battery to a value within a proper range, the decomposition of the non-aqueous electrolyte in the cathode is suppressed, thereby improving the cycle characteristics. For example, in JP-A-1992(Heisei 4)-249073, a method whereby by setting the specific surface area of the cathode active material to a value within a range from 0.01 to 3.0 m²/g, a reaction area of the cathode active material and an electrolytic solution is set to a proper size has been disclosed. According to such a method, since the decomposition of an amount exceeding a necessary amount of the electrolytic solution in the cathode can be suppressed, the decrease in battery capacitance that is caused by the progress of the charge/discharge cycle is suppressed and the cycle characteristics can be improved.

As mentioned above, there is such a problem that on the cathode side of the lithium ion secondary battery, since the oxidation atmosphere is enhanced near the cathode surface upon charging, the non-aqueous electrolyte is oxidation-decomposed, so that the cycle characteristics deteriorate.

There occurs such a problem that on the anode side of the lithium ion secondary battery, doping of the lithium ions dedoped from the cathode upon charging deteriorates in association with the progress of the charge/discharge cycle. If the doping of the lithium ions deteriorates, a part of the lithium ions is not doped between layers of the carbon material of the anode but is precipitated to the surface of the anode. Thus, since an amount of lithium ions having the active material function decreases and the battery capacitance decreases, the cycle characteristics deteriorate.

Therefore, to improve the cycle characteristics of the lithium ion secondary battery, it is necessary to suppress the oxidation of the non-aqueous electrolyte in the cathode and suppress the lithium precipitation that is caused in the anode.

According to JP-A-1992(Heisei 4)-249073, although such a technique that the oxidation decomposition of the non-aqueous electrolyte in the cathode is suppressed by setting the specific surface area of the cathode active material to the value within the proper range has been disclosed, nothing is considered with respect to the problem about the lithium precipitation in the anode active material and the anode. There is, consequently, such a problem that it is difficult to sufficiently improve the cycle characteristics even if the specific surface area of the cathode active material is merely set to the value within the proper range as shown in JP-A-1992(Heisei 4)-249073.

It is, therefore, desirable to provide a non-aqueous electrolyte secondary battery having excellent cycle characteristics in which decomposition of a non-aqueous electrolyte in a cathode is suppressed and precipitation of lithium in an anode is suppressed, thereby preventing a battery capacitance from decreasing.

### SUMMARY

According to an embodiment, there is provided a non-aqueous electrolyte secondary battery comprising: a cathode containing at least a cathode active material; an anode containing at least an anode active material; and a non-aqueous electrolyte, wherein a specific surface area of the cathode active material lies within a range from 0.1 m²/g or more to 0.8 m²/g or less and a specific surface area of the anode active material lies within a range from 0.2 m²/g or more to 5.0 m²/g or less.

It is preferable that the non-aqueous electrolyte is a gel electrolyte and in the gel electrolyte, a solution containing a non-aqueous solvent and an electrolytic salt is contained in a copolymer of polyvinylidene fluoride and hexafluoro propylene. This is because the battery is electrochemically stabilized as a result.

According to the embodiment, by setting the specific surface area of each of the cathode active material and the anode active material to the value within the proper range, the decomposition of the non-aqueous electrolyte in the cathode is suppressed and the precipitation of lithium in the anode is suppressed.

According to the embodiment, by suppressing the decomposition of the electrolyte in the cathode and by suppressing the precipitation of lithium in the anode, the non-aqueous electrolyte secondary battery having the excellent cycle characteristics can be obtained.

Other features are apparent from the following description taken in conjunction with the accompanying drawings, in which like reference characters designate the same or similar parts throughout the figures thereof.

Additional features and advantages are described herein, and will be apparent from, the following Detailed Description and the figures.

### BRIEF DESCRIPTION OF THE FIGURES

FIG. 1 is a perspective view showing a construction of an example of a non-aqueous electrolyte secondary battery according to an embodiment; and

FIG. 2 is a schematic diagram enlargedly showing a part of a battery element of the non-aqueous electrolyte secondary battery according to the embodiment.

### DETAILED DESCRIPTION

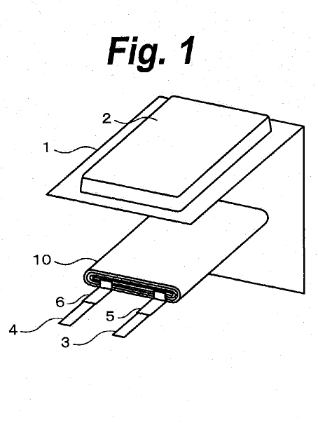

FIG. 1 shows a construction of an example of a non-aqueous electrolyte secondary battery according to an embodiment. The non-aqueous electrolyte secondary battery is constructed by enclosing a battery element 10 into a sheathing member 1 made of a moisture-proof laminate film and melt-bonding the circumference of the battery element 10, thereby sealing it. A cathode lead 3 and an anode lead 4 are provided for the battery element 10. Those leads are sandwiched between the sheathing members 1 and led out to the outside. Both surfaces of each of the cathode lead 3 and the anode lead 4 are covered with resin members 5 and 6 in order to improve adhesion with the sheathing member 1.

[Sheathing Member]

The sheathing member 1 has a laminate structure obtained by, for example, sequentially laminating an adhesive layer, a metal layer, and a surface protecting layer. The adhesive layer is made of a high polymer film. As a material constructing the high polymer film, for example, polypropylene PP, polyethylene PE, casted polypropylene (non-oriented polypropylene) CPP, linear low-density polyethylene LLDPE, or low-density polyethylene LDPE can be mentioned. The metal layer is made of a metal foil. As a material constructing the metal foil, for example, aluminum Al can be mentioned. As a material constructing the metal foil, a metal other than aluminum can be also used. As a material constructing the surface protecting layer, for example, nylon Ny or polyethylene terephthalate PET can be mentioned. The surface of the adhesive layer side becomes an enclosing surface on the side where the battery element 10 is enclosed.

[Battery Element]

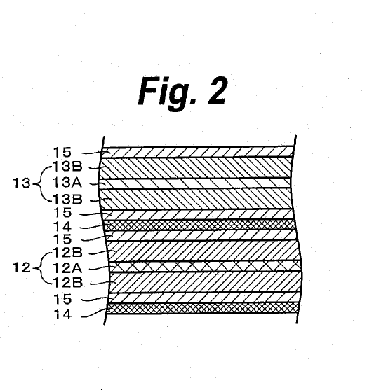

A construction of the battery element 10 is described hereinbelow. FIG. 2 enlargedly shows a part of the battery element 10 shown in FIG. 1. For example, as shown in FIG. 2, the battery element 10 is the winded type battery element 10 obtained by laminating a belt-shaped anode 13 where both of its surfaces are formed with gel electrolyte layers 15, a separator 14, a belt-shaped cathode 12 whose both surfaces are formed with the gel electrolyte layers 15, and the separator 14 and winding them in the longitudinal direction. In addition to the above embodiment, it should also be appreciated that the battery element 10 can be also made of only a non-aqueous electrolytic solution without using a gel electrolyte. Further, an embodiment of a battery like a rectangular battery obtained by enclosing a similar battery element into a metal casing in place of the laminate film is also possible.

[Cathode]

The cathode 12 is formed by a belt-shaped cathode collector 12A and cathode active material layers 12B formed on both surfaces of the cathode collector 12A. As a cathode collector 12A, for example, a metal foil such as aluminum Al foil, nickel Ni foil, stainless SUS foil, or the like can be used.

The cathode active material layer 12B is formed by, for example, containing one, two, or more kinds of cathode active materials into/from which lithium ions can be doped and dedoped, a conductive material, and a binder.

As a material of the cathode active material into/from which the lithium ions can be doped and dedoped, for example, a lithium-contained transition metal compound such as lithium oxide, lithium phosphorus oxide, lithium sulfide, or the like is proper. To raise the energy density, a lithium-contained transition metal oxide containing lithium, a transition metal element, and oxygen O is preferable. Particularly, it is much preferable that at least one kind selected from a group including cobalt Co, nickel Ni, manganese Mn, and iron Fe is contained as a transition metal element. As such a lithium-contained transition metal compound, for example, the following compounds can be mentioned: a lithium-contained transition metal oxide having a structure of a stratified rock-salt type shown by the following formula (1); a lithium composite phosphate having a structure of an olivin type shown by the following formula (2); and the like. Specifically speaking, LiCoO₂, LiNiO₂, LiNi_{c}Co_{1-c}O₂ (0<c<1), LiMn₂O₄, LiFePO₄, and the like can be mentioned. A plurality of kinds of transition metal elements can be also used. As an example of such a case, LiNi_{0.50}Co_{0.50}O₂, LiNi_{0.50}Co_{0.30}Mn_{0.20}O₂, and LiFe_{0.50}Mn_{0.50}PO₄ can be mentioned.
LiₚNi_{(1-q-r)}Mn_{q}M1ᵣO_{(2-y)}X_{z} (1)

In the formula, M1 is at least one kind among the elements selected from Groups 2 to 15 excluding Ni and Mn; X indicates at least one kind selected from the elements of Groups 16 and 17 excluding oxygen O; p is a value within a range of 0≦p≦1.5; q is a value within a range of 0≦q≦1.0; r is a value within a range of 0≦r≦1.0; y is a value within a range of −0.10≦y≦0.20; and z is a value within a range of 0≦z≦0.2.
LiₐM2_{b}PO₄ (2)

In the formula, M2 indicates at least one kind among the elements selected from Groups 2 to 15; a is a value within a range of 0≦a≦2.0; and b is a value within a range of 0.5≦b≦2.0.

A cathode material whose specific surface area lies within a range from 0.1 m²/g or more to 0.8 m²/g or less is used as a cathode active material. This is because if the specific surface area of the cathode active material is less than 0.1 m²/g, since a reaction area of the cathode active material and the electrolytic solution is small, a using efficiency of the cathode active material deteriorates and an ability of the cathode active material is not sufficiently effected, so that an initial capacitance of the battery decreases. This is also because if the specific surface area of the cathode active material exceeds 0.8 m²/g, since the decomposition of the non-aqueous electrolyte is heavily performed, the battery capacitance decreases and cycle characteristics deteriorate. The specific surface area is measured by a BET (Brunauer Emmett Teller) method by using “MacSorb HM model 1208” made by Mountech Co., Ltd.

As a conductive material, it is not particularly limited and any material can be used so long as the conductive material of a proper amount is mixed into the cathode active material and it can provide an electroconductivity. For example, a carbon material such as carbon black, graphite, or the like is used. As a binder, a well-known binder which is ordinarily used for a cathode mixture of such a kind of battery. Preferably, a fluororesin such as polyvinyl fluoride, polyvinylidene fluoride, polytetrafluoro ethylene, or the like is used.

[Anode]

The anode 13 is formed by a belt-shaped anode collector 13A and anode active material layers 13B formed on both surfaces of the anode collector 13A. The anode collector 13A is made of, for example, a metal foil such as copper Cu foil, nickel foil, stainless SUS foil, or the like.

The anode active material layer 13B is formed by containing, for example, an anode active material and, if necessary, a conductive material and a binder.

As an anode active material, a carbon material, a crystal, or an amorphous metal oxide into/from which lithium can be doped and dedoped is used. Specifically speaking, as a carbon material into/from which lithium can be doped and dedoped, a graphite, a non-easy-graphitizable carbon material, an easy-graphitizable carbon material, a high crystalline carbon material in which a crystalline structure has grown, and the like can be mentioned. More specifically speaking, the following materials can be used: a pyrolytic carbon class; a coke class (pitch coke, needle coke, petroleum coke); a graphite class; a glass-like carbon class; an organic high molecular compound baked material (obtained by baking and carbonating a phenol resin, a fran resin, or the like at a proper temperature); a carbon material such as carbon fiber, activated charcoal, carbon black, or the like; a polymer such as polyacetylene; and the like.

As another material of the anode active material, a metal which can form an alloy together with lithium or an alloy compound of such a metal can be mentioned. Specifically speaking, when a certain metal element which can form the alloy together with lithium is assumed to be M, the alloy compound mentioned here is a compound expressed by MₚM′_{q}Liᵣ (in the formula, M′ denotes one or more metal elements except an Li element and an M element; p indicates a numerical value larger than 0; and q and r indicate numerical values of 0 or more). Further, in the invention, elements such as boron B, silicon Si, arsenic As, and the like as semiconductor elements are also incorporated in the metal elements. Specifically speaking, the following metals and their alloy components can be mentioned: metals such as magnesium Mg, boron B, aluminum Al, gallium Ga, indium In, silicon Si, germanium Ge, tin Sn, lead Pb, antimony Sb, bismuth Bi, cadmium Cd, silver Ag, zinc Zn, hafnium Hf, zirconium Zr, and yttrium Y; and their alloy components, that is, for example, Li—Al, Li—Al-M (in the formula, M is one or more kinds selected from transition metal elements of Groups 2A, 3B, and 4B), AlSb, CuMgSb, and the like.

Among the elements as mentioned above, it is preferable to use a typical element of Group 3B as an element which can form the alloy together with lithium. Among the elements of Group 3B, it is preferable to use an element such as silicon Si, tin Sn, or the like or its alloy. Further, silicon Si or an alloy of silicon Si is particularly preferable. As a silicon Si alloy or a tin Sn alloy, specifically speaking, components expressed by MₓSi or MₓSn (in the formula, M is one or more metal elements excluding Si or Sn) are mentioned. Specifically speaking, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, and the like can be mentioned.

Further, a compound of Group 4B containing one or more non-metal elements and excluding carbon can be also used as an anode material of the invention. Two or more kinds of elements of Group 4B may be also contained in the anode material. A metal element containing lithium and excluding the elements of Group 4B can be also contained. For example, SiC, Si₃N₄, Si₂N₂O, Ge₂N₂O, SiOₓ (0≦x≦2), SNOₓ (0≦x≦2), LiSiO, LiSNO, and the like may be contained.

An anode material whose specific surface area lies within a range from 0.2 m²/g or more to 5.0 m²/g or less is used as an anode active material. This is because if the specific surface area of the anode active material is less than 0.2 m²/g, since a reaction area of the anode active material and the electrolytic solution is small, it is difficult to sufficiently dope lithium ions into the anode and precipitation of lithium is caused. Since precipitated lithium is dropped, an amount of lithium ions which can be doped into the anode decreases, the separator is also damaged by precipitated dendrite-like lithium, and a micro short-circuit occurs, so that the cycle characteristics deteriorate. This is also because if the specific surface area exceeds 5.0 m²/g, since the decomposition of the non-aqueous electrolyte occurs upon initial charging, a reaction area of the anode active material and the non-aqueous electrolyte decreases and an amount of lithium ions which are doped into the anode decreases, so that the initial capacitance decreases. The specific surface area is measured by the BET method by using “MacSorb HM model 1208” made by Mountech Co., Ltd.

As a conductive material, it is not particularly limited and any material can be used so long as an electroconductivity can be provided by mixing the conductive material of a proper amount into the anode active material. For example, a carbon material such as carbon black, graphite, or the like is used. As a binder, for example, polyvinylidene fluoride, styrene-butadiene rubber, or the like is used.

[Gel Electrolyte]

The gel electrolyte layer 15 contains an electrolytic solution and a high molecular compound serving as a holding member for holding the electrolytic solution and is in what is called a gel-state. The gel electrolyte layer 15 is preferable because a high ion conductivity can be obtained and a leakage of the liquid of the battery can be prevented.

As an electrolytic solution, a non-aqueous electrolytic solution obtained by dissolving an electrolytic salt into a non-aqueous solvent can be used. As a non-aqueous solvent, it is preferable to contain, for example, at least either ethylene carbonate or propylene carbonate. This is because the cycle characteristics can be improved. Particularly, if ethylene carbonate and propylene carbonate are mixed and contained, it is preferable because the cycle characteristics can be further improved. As a non-aqueous solvent, it is preferable to contain at least one kind selected from chain-like carbonic ester such as diethyl carbonate, dimethyl carbonate, ethylmethyl carbonate, methylpropyl carbonate, and the like. This is because the cycle characteristics can be improved.

Further, as a non-aqueous solvent, it is preferable to contain at least either 2,4-difluoroanisole and vinylene carbonate. This is because in the case of 2,4-difluoroanisole, the discharge capacitance can be improved and in the case of vinylene carbonate, the cycle characteristics can be further improved. Particularly, if they are mixed and used, since both of the discharge capacitance and the cycle characteristics can be improved, it is much preferable.

As a non-aqueous solvent, one, two, or more kinds of the following materials can be further contained: butylene carbonate; γ-butyrolactone; γ-valerolactone; a material obtained by replacing a part or all of a hydrogen radical of those compounds by a fluorine radical; 1,2-dimethoxy ethane; tetrahydrofuran; 2-methyl tetrahydrofuran; 1,3-dioxorane; 4-methyl-1,3-dioxorane; methyl acetate; methyl propionate; acetonitrile; glutaronitrile; adiponitrile; methoxy acetonitrile; 3-methoxy propylonitrile; N,N-dimethyl formamide; N-methylpyrrolidinone; N-methyl oxazolidinone; N,N-dimethyl imidazolidinone; nitromethane; nitroethane; sulfolan; dimethyl sulfoxide; trimethyl phosphate; and the like.

There is a case where by using a compound in which a part or all of hydrogen atoms of the materials contained in the above non-aqueous solvent group have been replaced by fluorine atoms, the reversibility of the electrode reaction is improved in dependence on an electrode which is combined. Therefore, those materials can be also properly used.

As a lithium salt as an electrolytic salt, for example, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBF₂₍₀ₓ₎, LiBOB, or LiBr is proper. One, two, or more kinds of them can be mixed and used. Among them, LiPF₆ is preferable because the high ion conductivity can be obtained and the cycle characteristics can be improved.

As a high molecular compound, for example, there can be mentioned: polyacrylonitrile; polyvinylidene fluoride; copolymer of vinylidene fluoride and hexafluoro propylene; polytetrafluoro ethylene; polyhexafluoro propylene; polyethylene oxide; polypropylene oxide; polyphosphazene; polysiloxane; polyvinyl acetate; polyvinyl alcohol; polymethyl methacrylate; polyacrylic acid; polymethacrylate; styrene-butadiene rubber; nitrile-butadiene rubber; polystyrene; polycarbonate; or the like. Polyacrylonitrile, polyvinylidene fluoride, polyhexafluoro propylene, or polyethylene oxide is preferable, particularly, from a viewpoint of electrochemical stability.

[Separator]

The separator 14 is formed by, for example, a porous membrane made of a material of a polyolefin system such as polypropylene PP, polyethylene PE, or the like or a porous membrane made of an inorganic material such as a nonwoven fabric cloth or the like made of ceramics. The separator 14 can also have a structure obtained by laminating those two or more kinds of porous membranes. Among them, a porous film made of polyethylene or polypropylene is most effective.

Generally, the separator 14 having a thickness of 5 to 50 μm can be preferably used. A thickness of 7 to 30 μm is much preferable. If the separator 14 is too thick, a filling amount of the active material decreases, the battery capacitance decreases, the ion conductivity deteriorates, and current characteristics deteriorate. On the contrary, if the separator 14 is too thin, a mechanical strength of the membrane decreases.

The non-aqueous electrolyte secondary battery constructed as mentioned above can be manufactured, for example, as follows.

[Manufacturing Step of Cathode]

The foregoing cathode active material, binder, and conductive material are uniformly mixed so as to form a cathode mixture. The cathode mixture is dispersed into the solvent and formed in a slurry-state by using a ball mill, a sand mill, a biaxial kneading machine, or the like as necessary. As a solvent, it is not particularly limited but any material can be used so long as it is inactive to the electrode material and can dissolve the binder. Either an inorganic solvent or an organic solvent can be used. For example, N-methyl-2-pyrrolidone NMP or the like is used. It is sufficient that the cathode active material, conductive material, binder, and solvent have uniformly been dispersed, and their mixture ratio is not limited. Subsequently, both surfaces of the cathode collector 12A are uniformly coated with the slurry by a doctor blade method or the like. Further, the cathode collector 12A is dried at a high temperature and the solvent is eliminated. Thereafter, by compression-molding it by, for example, a roll pressing machine, the cathode active material layers 12B are formed. Thus, the cathode 12 is formed.

The cathode lead 3 is welded to one end portion of the cathode 12 in the longitudinal direction by, for example, spot welding or ultrasonic welding. As a material of the cathode lead 3, for example, a metal such as aluminum or the like can be used.

[Manufacturing Step of Anode]

The foregoing anode active material, binder, and conductive material are uniformly mixed so as to form an anode mixture. The anode mixture is dispersed into the solvent and formed in a slurry-state. In this instance, in a manner similar to the case of the cathode mixture, the ball mill, sand mill, biaxial kneading machine, or the like can be also used. As a solvent, N-methyl-2-pyrrolidone NMP, methylethyl ketone, or the like is used. In a manner similar to the cathode active material, a mixture ratio of the anode active material, conductive material, binder, and solvent is not limited. Subsequently, both surfaces of the anode collector 13A are uniformly coated with the slurry by the doctor blade method or the like. Further, the anode collector 13A is dried at a high temperature and the solvent is eliminated. Thereafter, by compression-molding it by, for example, the roll pressing machine, the anode active material layers 13B are formed. Thus, the anode 13 is formed.

A coating apparatus is not particularly limited but a slide coating, a die coating of an extrusion type, a reverse roll, a gravure, a knife coater, a kiss coater, a microgravure, a rod coater, a blade coater, or the like can be used. Although a drying method is not particularly limited, a leave-dry, a blast drier, a hot-air drier, an infrared heater, a far-infrared heater, or the like can be used.

In a manner similar to the cathode 12, the anode lead 4 is also welded to one end portion of the anode 13 in the longitudinal direction by, for example, the spot welding or ultrasonic welding. As a material of the anode lead 4, for example, copper Cu, nickel Ni, or the like can be used.

[Assembling Step of Battery]

Each of the cathode 12 and the anode 13 formed as mentioned above is coated with a presolution containing a solvent, electrolytic salt, a high molecular compound, and a mixed solvent, and the mixed solvent is volatilized, thereby forming the gel electrolyte layer 15.

Subsequently, the cathode 12 and anode 13 on each of which the gel electrolyte layer 15 has been formed are laminated through the separator 14, thereby obtaining a laminate. After that, this laminate is wound in its longitudinal direction, thereby forming the winded battery element 10.

Subsequently, a concave portion 2 is formed by deep-drawing the sheathing member 1 made by a laminate film. The battery element 10 is inserted into the concave portion 2. An unprocessed portion of the sheathing member 1 is folded back to an upper portion of the concave portion 2. An outer peripheral portion of the concave portion 2 is thermally welded and sealed. By this method, the non-aqueous electrolyte secondary battery according to the embodiment is manufactured.

The non-aqueous electrolyte secondary battery with the foregoing construction can be used under such a condition that an open circuit voltage in the complete charging state per pair of cathode and anode lies within a range from 2.5 to 4.2 V. According to such a non-aqueous electrolyte secondary battery, by using the battery under such a condition that the specific surface areas of the cathode active material and the anode active material are set to values within proper ranges, the oxidation decomposition of the non-aqueous electrolyte in the cathode can be suppressed and the precipitation of lithium in the anode can be suppressed. Therefore, the non-aqueous electrolyte secondary battery having the excellent cycle characteristics can be obtained without deteriorating the battery capacitance.

### EXAMPLES

The embodiments are described by Examples hereinbelow. However, it should be appreciated that the embodiments are not limited only to those Examples.

### Example 1

In Example 1, non-aqueous electrolyte secondary batteries are manufactured by changing the specific surface area of the cathode active material as follows and an initial capacitance and a capacitance maintaining ratio after 500 cycles are obtained. Examples and Comparisons will be described in detail hereinbelow with reference to Table 1.

### Example 1-1

[Manufacturing of Cathode]

Lithium cobalt acid LiCoO₂ whose specific surface area is equal to 0.1 m²/g of 91 weight % as a cathode active material, powdery graphite of 6 weight % as a conductive material, and powdery polyvinylidene fluoride of 3 weight % as a binder are uniformly mixed, thereby adjusting a cathode mixture. The cathode mixture is dispersed into N-methyl-2-pyrrolidone, thereby forming a cathode mixture slurry. Both surfaces of an aluminum foil serving as a cathode collector are uniformly coated with the cathode mixture slurry and the cathode collector is dried at a reduced pressure, thereby forming a cathode active material layer.

Subsequently, the cathode active material layer is molded with a pressure by the roll pressing machine, thereby forming a cathode sheet. The cathode sheet is cut out into a size of 50 mm in the vertical direction and 350 mm in the lateral direction, thereby forming a cathode. A lead made of aluminum is welded to the active material non-coating portion, thereby manufacturing the cathode.

[Manufacturing of Anode]

Artificial graphite of 90 weight % which has been ground and adjusted so that a specific surface area is equal to 1.0 m²/g as an anode active material and powdery polyvinylidene fluoride of 10 weight % as a binder are uniformly mixed, thereby adjusting an anode mixture. The anode mixture is dispersed into N-methyl-2-pyrrolidone, thereby forming an anode mixture slurry. Subsequently, both surfaces of a copper foil serving as an anode collector are uniformly coated with the anode mixture slurry and the anode collector is dried at a reduced pressure, thereby forming an anode active material layer.

Subsequently, the anode active material layer is molded with a pressure by the roll pressing machine, thereby forming an anode sheet. The anode sheet is cut out into a size of 52 mm in the vertical direction and 370 mm in the lateral direction, thereby forming an anode. A lead made of nickel having a width of 3 mm is welded to the active material non-coating portion, thereby manufacturing the anode.

[Manufacturing of Gel Electrolyte]

Polyvinylidene fluoride to which hexafluoro propylene has been copolymerized at a rate of 6.9%, a non-aqueous electrolytic solution, and dimethyl carbonate DMC as a dilution solvent are mixed, stirred, and dissolved, thereby obtaining a sol electrolytic solution. The non-aqueous electrolytic solution is formed by mixing ethylene carbonate and propylene carbonate at a volume ratio of 1:1 and dissolving LiPF₆ of 0.6 mol/kg as an electrolytic salt therein. Subsequently, both surfaces of each of the cathode and the anode are uniformly coated with the obtained sol electrolytic solution and, thereafter, the cathode and the anode are dried and the solvent is eliminated. In this manner, gel electrolyte layers are formed on both surfaces of each of the cathode and the anode.

[Assembling Step of Battery]

The belt-shaped cathode which has been manufactured as mentioned above and in which the gel electrolyte layers have been formed on both surfaces and the belt-shaped anode which has been manufactured as mentioned above and in which the gel electrolyte layers have been formed on both surfaces are laminated through separator made of a polyethylene oriented film and wound in the longitudinal direction, thereby manufacturing a battery element. Subsequently, the battery element is externally covered with a laminate film, thereby sealing the circumference of the battery element. In this manner, the non-aqueous electrolyte secondary battery of Example 1-1 is manufactured.

### Example 1-2

A non-aqueous electrolyte secondary battery of Example 1-2 is manufactured in a manner similar to Example 1-1 except that lithium cobalt acid LiCoO₂ whose specific surface area is equal to 0.5 m²/g is used as a cathode active material.

### Example 1-3

A non-aqueous electrolyte secondary battery of Example 1-3 is manufactured in a manner similar to Example 1-1 except that lithium cobalt acid LiCoO₂ whose specific surface area is equal to 0.8 m²/g is used as a cathode active material.

<Comparison 1-1>

A non-aqueous electrolyte secondary battery of Comparison 1-1 is manufactured in a manner similar to Example 1-1 except that lithium cobalt acid LiCoO₂ whose specific surface area is equal to 0.05 m²/g is used as a cathode active material.

<Comparison 1-2>

A non-aqueous electrolyte secondary battery of Comparison 1-2 is manufactured in a manner similar to Example 1-1 except that lithium cobalt acid LiCoO₂ whose specific surface area is equal to 1.0 m²/g is used as a cathode active material.

With respect to each of the non-aqueous electrolyte secondary batteries manufactured as mentioned above, (a) an initial capacitance and (b) a capacitance maintaining ratio after 500 cycles are obtained as follows.

(a) Initial Capacitance

With respect to each of the non-aqueous electrolyte secondary batteries of Examples and Comparisons mentioned above, constant-current charging is performed at 0.1 C, a charging mode is switched to constant-voltage charging at a point of time when a charge voltage reaches 4.2V, and the charging is performed until a total charging time reaches 12 hours. Subsequently, discharging is performed at 0.2 C, the discharging is finished at a point of time when the voltage reaches 3.0V, and the discharge capacitance in this instance is measured and used as an initial capacitance.

(b) Capacitance Maintaining Ratio after 500 Cycles

With respect to each of the non-aqueous electrolyte secondary batteries of Examples and Comparisons mentioned above, the constant-current charging is performed at 0.1 C, the charging mode is switched to the constant-voltage charging at a point of time when a charge voltage reaches 4.2V, and the charging is performed until a total charging time reaches 2.5 hours. Subsequently, the discharging is performed at 1.0 C, the discharging is finished at a point of time when the voltage reaches 3.0V, and the discharge capacitance in this instance is measured. Such a charge/discharge cycle is performed by 500 cycles and the discharge capacitance in the 500 th cycle is measured. Subsequently, the capacitance maintaining ratio after 500 cycles is obtained by
{(discharge capacitance in the 500th cycle/discharge capacitance in the first cycle)×100}

The initial capacitances and the capacitance maintaining ratios after 500 cycles of Examples 1-1 to 1-3 and Comparisons 1-1 and 1-2 are shown in Table 1. It is assumed that the battery in which the initial capacitance is equal to or larger than 780 mAh and the capacitance maintaining ratio after 500 cycles is equal to or larger than 80% is a good product.

TABLE 1

| | | | | CAPACITANCE |
|---|---|---|---|---|
| | SPECIFIC SURFACE | SPECIFIC SURFACE | | MAINTAINING |
| | AREA OF CATHODE | AREA OF ANODE | INITIAL | RATIO AFTER |
| | ACTIVE MATERAL | ACTIVE MATERAL | CAPACITANCE | 500 CYCLES |
| | [m²/g] | [m²/g] | [mAh] | [%] |
| EXAMPLE1-1 | 0.1 | 1.0 | 800 | 83 |
| EXAMPLE1-2 | 0.5 | 1.0 | 810 | 82 |
| EXAMPLE1-3 | 0.8 | 1.0 | 810 | 80 |
| COMPARISON1-1 | 0.05 | 1.0 | 760 | 84 |
| COMPARISON1-2 | 1.0 | 1.0 | 800 | 60 |

As will be understood from the results of Examples 1-1 to 1-3, when the specific surface area of the cathode active material lies within a range from 0.1 m²/g or more to 0.8 m²/g or less, the decrease in the initial capacitance and the decrease in the capacitance maintaining ratio after 500 cycles can be suppressed.

On the other hand, as shown in Comparison 1-1, if the specific surface area of the cathode active material is smaller than 0.1 m²/g, the initial capacitance decreases. It is considered that this is because since the reaction area of the cathode active material and the non-aqueous electrolyte is small, the using efficiency of the cathode active material deteriorates and the initial capacitance decreases. As shown in Comparison 1-2, if the specific surface area of the cathode active material is larger than 0.8 m²/g, the capacitance maintaining ratio after 500 cycles decreases. This is because the decomposition of the electrolytic solution occurs on the cathode side and the battery capacitance decreases.

From the above results, it has been found that by setting the specific surface area of the cathode active material to a value within the range from 0.1 m²/g or more to 0.8 m²/g or less, the non-aqueous electrolyte secondary battery whose initial capacitance is large and which has the excellent cycle characteristics can be obtained.

### Example 2

In Example 2, non-aqueous electrolyte secondary batteries are manufactured by changing the specific surface area of the anode active material as follows and an initial capacitance and a capacitance maintaining ratio after 500 cycles are obtained in a manner similar to Example 1. Examples and Comparisons will be described in detail hereinbelow with reference to Table 2.

### Example 2-1

A non-aqueous electrolyte secondary battery of Example 2-1 is manufactured in a manner similar to Example 1-1 except that lithium cobalt acid LiCoO₂ whose specific surface area is equal to 0.5 m²/g is used as a cathode active material and artificial graphite whose specific surface area is equal to 0.2 m²/g is used as an anode active material.

### Example 2-2

A non-aqueous electrolyte secondary battery of Example 2-2 is manufactured in a manner similar to Example 2-1 except that the artificial graphite whose specific surface area is equal to 2.0 m²/g is used as an anode active material.

### Example 2-3

A non-aqueous electrolyte secondary battery of Example 2-3 is manufactured in a manner similar to Example 2-1 except that the artificial graphite whose specific surface area is equal to 5.0 m²/g is used as an anode active material.

<Comparison 2-1>

A non-aqueous electrolyte secondary battery of Comparison 2-1 is manufactured in a manner similar to Example 2-1 except that the artificial graphite whose specific surface area is equal to 0.1 m²/g is used as an anode active material.

<Comparison 2-2>

A non-aqueous electrolyte secondary battery of Comparison 2-2 is manufactured in a manner similar to Example 2-1 except that the artificial graphite whose specific surface area is equal to 7.0 m²/g is used as an anode active material.

With respect to each of the non-aqueous electrolyte secondary batteries of Examples 2-1 to 2-3 and Comparisons 2-1 and 2-2, (a) an initial capacitance and (b) a capacitance maintaining ratio after 500 cycles are obtained in a manner similar to Example 1. Results are shown in Table 2.

TABLE 2

| | | | | CAPACITANCE |
|---|---|---|---|---|
| | SPECIFIC SURFACE | SPECIFIC SURFACE | | MAINTAINING |
| | AREA OF CATHODE | AREA OF ANODE | INITIAL | RATIO AFTER |
| | ACTIVE MATERAL | ACTIVE MATERAL | CAPACITANCE | 500 CYCLES |
| | [m²/g] | [m²/g] | [mAh] | [%] |
| EXAMPLE2-1 | 0.5 | 0.2 | 800 | 80 |
| EXAMPLE2-2 | 0.5 | 2.0 | 820 | 82 |
| EXAMPLE2-3 | 0.5 | 5.0 | 810 | 83 |
| COMPARISON2-1 | 0.5 | 0.1 | 770 | 60 |
| COMPARISON2-2 | 0.5 | 7.0 | 730 | 70 |

As will be understood from the results of Examples 2-1 to 2-3, when the specific surface area of the anode active material lies within a range from 0.2 m²/g or more to 5.0 m²/g or less, the decrease in the initial capacitance and the decrease in the capacitance maintaining ratio after 500 cycles can be suppressed.

On the other hand, as shown in Comparison 2-1, if the specific surface area of the anode active material is smaller than 0.2 m²/g, since the reaction area of the anode active material and the non-aqueous electrolyte is small, the initial capacitance of the battery decreases and, since the lithium precipitation has occurred, the capacitance maintaining ratio after 500 cycles decreases. As shown in Comparison 2-2, if the specific surface area of the anode active material is larger than 5 m²/g, since the decomposition of the electrolytic solution has occurred upon initial charging, the initial capacitance and the capacitance maintaining ratio of the battery decrease.

From the above results, it has been found that by setting the specific surface area of the anode active material to a value within the range from 0.2 m²/g or more to 5.0 m²/g or less, the non-aqueous electrolyte secondary battery whose initial capacitance is large and which has the excellent cycle characteristics can be obtained.

### Example 3

In Example 3, the non-aqueous electrolyte secondary batteries are manufactured by changing the specific surface area of each of the cathode active material and the anode active material as follows and an initial capacitance and a capacitance maintaining ratio after 500 cycles are obtained in a manner similar to Example 1. Values of the specific surface areas of the cathode active material and the anode active material used in Examples 3-1 to 3-4 in Example 3 are evaluated by combining the minimum value and the maximum value within the ranges of the specific surface areas whose effects could be confirmed from the results of Examples 1 and 2 mentioned above, respectively. Examples and Comparisons will be described in detail hereinbelow with reference to Table 3.

### Example 3-1

A non-aqueous electrolyte secondary battery of Example 3-1 is manufactured in a manner similar to Example 1-1 except that lithium cobalt acid LiCoO₂ whose specific surface area is equal to 0.1 m²/g is used as a cathode active material and C the artificial graphite whose specific surface area is equal to 0.2 m²/g is used as an anode active material.

### Example 3-2

A non-aqueous electrolyte secondary battery of Example 3-2 is manufactured in a manner similar to Example 1-1 except that lithium cobalt acid LiCoO₂ whose specific surface area is equal to 0.1 m²/g is used as a cathode active material and the artificial graphite whose specific surface area is equal to 5.0 m²/g is used as an anode active material.

### Example 3-3

A non-aqueous electrolyte secondary battery of Example 3-3 is manufactured in a manner similar to Example 1-1 except that lithium cobalt acid LiCoO₂ whose specific surface area is equal to 0.8 m²/g is used as a cathode active material and the artificial graphite whose specific surface area is equal to 0.2 m²/g is used as an anode active material.

### Example 3-4

A non-aqueous electrolyte secondary battery of Example 3-4 is manufactured in a manner similar to Example 1-1 except that lithium cobalt acid LiCoO₂ whose specific surface area is equal to 0.8 m²/g is used as a cathode active material and the artificial graphite whose specific surface area is equal to 5.0 m²/g is used as an anode active material.

<Comparison 3-1>

A non-aqueous electrolyte secondary battery of Comparison 3-1 is manufactured in a manner similar to Example 1-1 except that lithium cobalt acid LiCoO₂ whose specific surface area is equal to 0.05 m²/g is used as a cathode active material and the artificial graphite whose specific surface area is equal to 0.1 m²/g is used as an anode active material.

<Comparison 3-2>

A non-aqueous electrolyte secondary battery of Comparison 3-2 is manufactured in a manner similar to Example 1-1 except that lithium cobalt acid LiCoO₂ whose specific surface area is equal to 1.0 m²/g is used as a cathode active material and the artificial graphite whose specific surface area is equal to 7.0 m²/g is used as an anode active material.

<Comparison 3-3>

A non-aqueous electrolyte secondary battery of Comparison 3-3 is manufactured in a manner similar to Example 1-1 except that lithium cobalt acid LiCoO₂ whose specific surface area is equal to 0.1 m²/g is used as a cathode active material and the artificial graphite whose specific surface area is equal to 0.1 m²/g is used as an anode active material.

<Comparison 3-4>

A non-aqueous electrolyte secondary battery of Comparison 3-4 is manufactured in a manner similar to Example 1-1 except that lithium cobalt acid LiCoO₂ whose specific surface area is equal to 0.9 m²/g is used as a cathode active material and the artificial graphite whose specific surface area is equal to 5.0 m²/g is used as an anode active material.

With respect to each of the non-aqueous electrolyte secondary batteries of Examples 3-1 to Comparisons 3-4, (a) an initial capacitance and (b) a capacitance maintaining ratio after 500 cycles are obtained in a manner similar to the measuring method used in Example 1. Results are shown in Table 3.

TABLE 3

| | | | | CAPACITANCE |
|---|---|---|---|---|
| | SPECIFIC SURFACE | SPECIFIC SURFACE | | MAINTAINING |
| | AREA OF CATHODE | AREA OF ANODE | INITIAL | RATIO AFTER |
| | ACTIVE MATERAL | ACTIVE MATERAL | CAPACITANCE | 500 CYCLES |
| | [m²/g] | [m²/g] | [mAh] | [%] |
| EXAMPLE3-1 | 0.1 | 0.2 | 800 | 80 |
| EXAMPLE3-2 | 0.1 | 5.0 | 790 | 82 |
| EXAMPLE3-3 | 0.8 | 0.2 | 810 | 80 |
| EXAMPLE3-4 | 0.8 | 5.0 | 800 | 83 |
| COMPARISON3-1 | 0.05 | 0.1 | 730 | 60 |
| COMPARISON3-2 | 1.0 | 7.0 | 770 | 65 |
| COMPARISON3-3 | 0.1 | 0.1 | 750 | 62 |
| COMPARISON3-4 | 0.9 | 5.0 | 800 | 70 |

As will be understood from the results of Examples 3-1 to 3-4, if the cathode active material whose specific surface area lies within a range from 0.1 m²/g or more to 0.8 m²/g or less and the anode active material whose specific surface area lies within a range from 0.2 m²/g or more to 5.0 m²/g or less are combined, the decrease in the initial capacitance and the decrease in the capacitance maintaining ratio after 500 cycles can be suppressed in any combination.

On the other hand, as shown in Comparisons 3-1 and 3-2, if the specific surface area of the cathode active material is out of the range from 0.1 m²/g or more to 0.8 m²/g or less and the specific surface area of the anode active material is out of the range from 0.2 m²/g or more to 5.0 m²/g or less, the initial capacitance and the capacitance maintaining ratio after 500 cycles decrease.

As will be understood by comparing Example 3-1 and Comparison 3-3, if the specific surface area of the anode active material is out of the range from 0.2 m²/g or more to 5.0 m²/g or less, the initial capacitance and the capacitance maintaining ratio after 500 cycles decrease. As will be understood by comparing Example 3-4 and Comparison 3-4, if the specific surface area of the cathode active material is out of the range from 0.1 m²/g or more to 0.8 m²/g or less, the capacitance maintaining ratio after 500 cycles decreases.

From the above results, it has been found that if the cathode active material whose specific surface area lies within the range from 0.1 m²/g or more to 0.8 m²/g or less is used as a cathode and the anode active material whose specific surface area lies within the range from 0.2 m²/g or more to 5.0 m²/g or less is used as an anode, the non-aqueous electrolyte secondary battery whose initial capacitance is large and which has the excellent cycle characteristics can be obtained.

Although the embodiment has specifically been described above, various modifications based on the technical ideas are possible. For example, the numerical values mentioned in the above embodiment are only an example and different numerical values may be used as necessary.

The shape of the non-aqueous electrolyte secondary battery is not limited to the shape shown in the above embodiment but, for example, the invention can be also applied to batteries of various shapes such as coin type, button type, cylindrical type, rectangular type, and the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A non-aqueous electrolyte secondary battery comprising:
a cathode including at least a cathode active material;
an anode including at least an anode active material; and
a non-aqueous electrolyte,
wherein a specific surface area of said cathode active material ranges from 0.1 m²/g or more to 0.8 m²/g or less and
a specific surface area of said anode active material ranges from 0.2 m²/g or more to 5.0 m²/g or less.

2. The battery according to claim 1, wherein
said non-aqueous electrolyte is a gel electrolyte and
in said gel electrolyte, a solution containing a non-aqueous solvent and an electrolytic salt is contained in a copolymer of polyvinylidene fluoride and hexafluoro propylene.
